(19) United States
(12) Patent Application Publication
(10) Pub. No.: US 2026/0128963 A1
(43) Pub. Date: May 7, 2026

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Jingran CHEN, Dongguan (CN)

(21) Appl. No.: 19/439,706

(22) Filed: Jan. 5, 2026

Related U.S. Application Data
(63) Continuation of application No. PCT/CN2023/112649, filed on Aug. 11, 2023.

(51) Int. Cl. H04L 41/16; H04W 24/02

(52) U.S. Cl. CPC H04L 41/16; H04W 24/02

(57) ABSTRACT

A communication method includes: receiving, by a terminal device, a configuration parameter in a feature profile of a first use case, model data required for the first use case, and a first feature identification of the first use case; and transmitting, by the terminal device, an execution result of the first use case, where the execution result comprises the first feature identification of the first use case.

### CROSS-REFERENCE TO RELATED APPLICATION

The present disclosure is a Continuation Application of PCT/CN2023/112649 filed Aug. 11, 2023, which is incorporated herein by reference in its entirety.

### TECHNICAL FIELD

The present application relates to the field of communications, and in particular, to a communication method, a terminal device, and a network device.

### BACKGROUND

In order to generate an artificial intelligence (AI) model that better meets user needs, model training requires more-dimensional user data. The user data is distributed across various nodes such as terminals, base stations, core networks, and third-party (over the top OTT) application servers. By collecting parameters for the same use case from various nodes and using the collected parameters for model training, the model effect can be improved. How to collect data for the same use case from different nodes during the training or execution of a machine learning model is a problem that needs to be solved.

### SUMMARY

The embodiments of the present application provide a communication method, including:
transmitting, by a first network device, a feature profile acquisition request of a first use case to a second network device, where the feature profile acquisition request carries a first feature identification of the first use case; and
receiving, by the first network device, a feature profile corresponding to the first feature identification from the second network device.

The embodiments of the present application provide a communication method, including:
receiving, by a second network device, a feature profile acquisition request of a first use case, where the feature profile acquisition request carries a first feature identification of the first use case; and
transmitting, by the second network device, a feature profile corresponding to the first feature identification.

The embodiments of the present application provide a communication method, including:
receiving, by a third network device, a feature profile of a first use case;
determining, by the third network device, at least one of a network device, a terminal device or a node required to execute the first use case based on the feature profile; and
transmitting, by the third network device, a configuration parameter in the feature profile to the at least one of the network device, the terminal device or the node required to execute the first use case.

The embodiments of the present application provide a communication method, including:
transmitting, by a fourth network device, a first execution request to a first network device, where the first execution request includes a feature identification of a first use case; and
receiving, by the fourth network device, an execution result of the first use case from the first network device, where the execution result includes the feature identification of the first use case.

The embodiments of the present application provide a communication method, including:
receiving, by a terminal device, a configuration parameter in a feature profile of a first use case, model data required for the first use case, and a first feature identification of the first use case; and
transmitting, by the terminal device, an execution result of the first use case, where the execution result includes the first feature identification of the first use case.

The embodiments of the present application provide a communication method, including:
receiving, by a core network element or an access network device, a configuration parameter in a feature profile of a first use case, model data required for the first use case, and a first feature identification of the first use case; and
transmitting, by the core network element or the access network device, an execution result of the first use case, where the execution result includes the first feature identification of the first use case.

The embodiments of the present application provide a first network device, including:
a first transceiver unit, configured to: transmit a feature profile acquisition request of a first use case to a second network device, where the feature profile acquisition request carries a first feature identification of the first use case; and receive a feature profile corresponding to the first feature identification from the second network device.

The embodiments of the present application provide a second network device, including:
a second transceiver unit, configured to: receive a feature profile acquisition request of a first use case, where the feature profile acquisition request carries a first feature identification of the first use case; and transmit a feature profile corresponding to the first feature identification.

The embodiments of the present application provide a third network device, including:
a third transceiver unit, configured to receive a feature profile of a first use case; and
a first determining unit, configured to determine at least one of a network device, a terminal device or a node required to execute the first use case based on the feature profile;
where the third transceiver unit is further configured to transmit a configuration parameter in the feature profile to the at least one of the network device, the terminal device or the node required to execute the first use case.

The embodiments of the present application provide a fourth network device, including:
a fourth transceiver unit, configured to: transmit a first execution request to a first network device, where the first execution request includes a feature identification of a first use case; and receive an execution result of the first use case from the first network device, where the execution result includes the feature identification of the first use case.

The embodiments of the present application provide a terminal device, including:
a fifth transceiver unit, configured to: receive a configuration parameter in a feature profile of a first use case, model data required for the first use case, and a first feature identification of the first use case; and transmit an execution result of the first use case, where the execution result includes the first feature identification of the first use case.

The embodiment of the present application provides a core network element, including:
a sixth transceiver unit, configured to: receive a configuration parameter in a feature profile of a first use case, model data required for the first use case, and a first feature identification of the first use case; and transmit an execution result of the first use case, where the execution result includes the first feature identification of the first use case.

The embodiments of the present application provide an access network device, including:
a seventh transceiver unit, configured to: receive a configuration parameter in a feature profile of a first use case, model data required for the first use case, and a first feature identification of the first use case; and transmit an execution result of the first use case, where the execution result includes the first feature identification of the first use case.

The embodiments of the present application further provide a communication device, including: a processor, a memory and a transceiver. The memory is configured to store a computer program, and the processor is configured to invoke the computer program stored in the memory and run the computer program, and control the transceiver, to cause the device to perform the above communication method.

The embodiments of the present application provide a chip, configured to implement the above communication method.

Specifically, the chip includes: a processor, configured to invoke a computer program from a memory and run the computer program, to cause a device equipped with the chip to perform the above communication method.

The embodiments of the present application provide a non-transitory computer-readable storage medium, configured to store a computer program, where the computer program, when executed by a device, causes the device to perform the above communication method.

The embodiments of the present application provide a computer program product, including computer program instructions, where the computer program instructions cause a computer to perform the above communication method.

The embodiments of the present application provide a computer program, where the computer program, when run on a computer, causes the computer to perform the above communication method.

### BRIEF DESCRIPTION OF THE DRAWINGS

FIG. 1 is a schematic diagram of an application scenario according to embodiments of the present application.

FIG. 2 is a schematic diagram of a training process of a vertical federated learning architecture.

FIG. 3 is a schematic diagram of an inference process of a vertical federated learning architecture.

FIG. 4 is a schematic diagram of a 5G network structure.

FIG. 5 is a schematic flowchart of a communication method 500 according to an embodiment of the present application.

FIG. 6 is a schematic flowchart of a communication method 600 according to an embodiment of the present application.

FIG. 7 is a schematic flowchart of a communication method 700 according to an embodiment of the present application.

FIG. 8 is a schematic flowchart of a communication method 800 according to an embodiment of the present application.

FIG. 9 is a schematic flowchart of a communication method 900 according to an embodiment of the present application.

FIG. 10 is a schematic flowchart of a communication method 1000 according to an embodiment of the present application.

FIG. 11 is a schematic flowchart of a communication method 1100 according to an embodiment of the present application.

FIG. 12 is a schematic flowchart of a communication method 1200 according to an embodiment of the present application.

FIG. 13 is an implementation flowchart of Embodiment 2 of the present application.

FIG. 14 is an implementation flowchart of Embodiment 3 of the present application.

FIG. 15 is an implementation flowchart of Embodiment 4 of the present application.

FIG. 16 is a schematic block diagram of a first network device 1600 according to an embodiment of the present application.

FIG. 17 is a schematic block diagram of a first network device 1700 according to an embodiment of the present application.

FIG. 18 is a schematic block diagram of a second network device 1800 according to an embodiment of the present application.

FIG. 19 is a schematic block diagram of a second network device 1900 according to an embodiment of the present application.

FIG. 20 is a schematic block diagram of a third network device 2000 according to an embodiment of the present application.

FIG. 21 is a schematic block diagram of a fourth network device 2100 according to an embodiment of the present application.

FIG. 22 is a schematic block diagram of a terminal device 2200 according to an embodiment of the present application.

FIG. 23 is a schematic block diagram of a core network element 2300 according to an embodiment of the present application.

FIG. 24 is a schematic block diagram of an access network device 2400 according to an embodiment of the present application.

FIG. 25 is a schematic block diagram of a communication device according to embodiments of the present application.

FIG. 26 is a schematic block diagram of a chip according to embodiments of the present application.

### DETAILED DESCRIPTION

Technical solutions in the embodiments of the present application will be described below in conjunction with drawings in the embodiments of the present application.

The technical solutions in the embodiments of the present application may be applied to various communication systems, such as a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial communication network (non-terrestrial network, NTN) system, a universal mobile telecommunication system (UMTS), a wireless local area network (WLAN) system, a wireless fidelity (WiFi) system, a 5th-generation (5G) communication system, or other communication systems.

Generally, traditional communication systems support a limited number of connections, which is also easy to implement. However, with the development of the communication technology, mobile communication systems will not only support traditional communications, but also support, for example, device to device (D2D) communication, machine to machine (M2M) communication, machine type communication (MTC), vehicle to vehicle (V2V) communication, or vehicle to everything (V2X) communication, etc. The embodiments of the present application may also be applied to these communication systems.

In an implementation, the communication system in the embodiments of the present application may be applied to a carrier aggregation (CA) scenario, a dual connectivity (DC) scenario, or a standalone (SA) networking scenario.

In an implementation, the communication system in the embodiments of the present application may be applied to an unlicensed spectrum, where the unlicensed spectrum may also be considered as a shared spectrum. Alternatively, the communication system in the embodiments of the present application may be applied to a licensed spectrum, where the licensed spectrum may also be considered as an unshared spectrum.

In the embodiments of the present application, various embodiments are described in conjunction with network device(s) and terminal device(s). The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus.

The terminal device may be a station (ST) in WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, an in-vehicle device, a wearable device, a terminal device in a next-generation communication system (e.g., an NR network), or a terminal device in a future evolved public land mobile network (PLMN).

In the embodiments of the present application, the terminal device may be deployed on land, including indoor or outdoor, handheld, wearable, or in-vehicle; or the terminal device may be deployed on water (e.g., on a steamship); or the terminal device may be deployed in air (e.g., on an airplane, on a balloon, or on a satellite).

In the embodiments of the present application, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

As an example but not a limitation, in the embodiments of the present application, the terminal device may also be a wearable device. The wearable device, which can also be referred to as a wearable smart device, is a general term of devices that are developed by intelligent design on daily wears by using a wearable technology and can be worn, such as glasses, gloves, watches, clothing, and shoes. The wearable device is a portable device that is worn directly on the body, or integrated into the clothes or accessories of users. The wearable device is not only a hardware device, but also implements powerful functions by software support as well as data interaction or cloud interaction. Generalized wearable smart devices include devices that have full functions and large sizes, and can implement all or part of functions without relying on smart phones, such as smart watches or smart glasses, and include devices that only focus on a certain type of application functions and need to be used in conjunction with other devices (e.g., smart phones), such as various smart bracelets or smart jewelries for monitoring physical signs.

In the embodiments of the present application, the network device may be a device used for communicating with a mobile device. The network device may be an access point (AP) in WLAN, an evolutional base station (evolutional Node B, eNB or eNodeB) in LTE, a relay station or an access point, an in-vehicle device, a wearable device, a network device (gNB) in an NR network, a network device in a future evolved PLMN, or a network device in an NTN network.

As an example but not a limitation, in the embodiments of the present application, the network device may have mobile characteristics. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, or in water, or at other places.

In the embodiments of the present application, the network device may provide services for a cell, and the terminal device may communicate with the network device through a transmission resource (e.g., a frequency domain resource, or a spectrum resource) used by the cell. The cell may be a cell corresponding to the network device (e.g., a base station). The cell may belong to a macro base station, or belong to a base station corresponding to small cells. Here, the small cells may include: a metro cell, a micro cell, a pico cell, a femto cell, etc. These small cells have characteristics of small coverage and low transmission power, and are suitable for providing high-speed data transmission services.

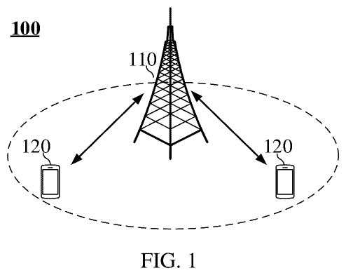

FIG. 1 exemplarily shows a communication system 100. The communication system includes a network device 110 and two terminal devices 120. In an implementation, the communication system 100 may include multiple network devices 110, and within the coverage range of each network device 110, another number of terminal devices 120 may be included, which is not limited in the embodiments of the present application.

In an implementation, the communication system 100 may further include other network entities such as a mobility management entity (MME) and an access and mobility management function (AMF), which is not limited in the embodiments of the present application.

Network devices may include an access network device and a core network device. That is, the wireless communication system further includes multiple core networks for communicating with access network devices. The access network device may be an evolutional base station (evolutional Node B, shorted for eNB or e-NodeB), a macro base station, a micro base station (also referred to as a “small base station”), a pico base station, an access point (AP), a transmission point (TP) or a new generation base station (new generation Node B, gNodeB) in a long-term evolution (LTE) system, a next-generation (mobile communication system) (next radio, NR) system or an authorized auxiliary access long-term evolution (LAA-LTE) system.

It should be understood that, in the embodiments of the present application, a device with a communication function in the network/system may be referred to as a communication device. The communication system shown in FIG. 1 is taken as an example, communication devices may include a network device with a communication function and a terminal device with a communication function. The network device and the terminal device may be the specific devices in the embodiments of the present application, which are not repeated here. The communication devices may further include other devices in the communication system, such as a network controller, a mobility management entity, or other network entities, which are not limited in the embodiments of the present application.

It should be understood that the terms “system” and “network” are often used interchangeably herein. The term “and/or” used herein is only an association relationship for describing associated objects, which indicates that there may be three kinds of relationships. For example, “A and/or B” may represent three situations where: A exists alone, both A and B exist, and B exists alone. In addition, the character “/” used herein generally indicates that associated objects before and after this character are in an “or” relationship.

It should be understood that, “indicate/indicated/indicating/indication” mentioned in the embodiments of the present application may mean a direct indication or an indirect indication, or may mean that there is an association relationship. For example, A indicates B, which may mean that A directly indicates B, for example, B may be acquired by A. Alternatively, A indicates B, which may mean that A indirectly indicates B, for example, A indicates C, and B may be acquired by C. Alternatively, A indicates B, which may mean that there is an association relationship between A and B.

In the description of the embodiments of the present application, the term “correspond/corresponding/correspondence” may mean that there is a direct correspondence or an indirect correspondence between the two, or may mean that there is an association relationship between the two, or may mean a relationship of indicating and being indicated, or a relationship of configuring and being configured.

To facilitate understanding of the technical solutions in the embodiments of the present application, the related technologies in the embodiments of the present application are described below. The following related technologies, as optional solutions, may be arbitrarily combined with the technical solutions in the embodiments of the present application, and those combined solutions all fall within the protection scope of the embodiments of the present application.

### I. Vertical Federated Learning (VFL):

in order to generate an AI model that better meets user needs, model training requires more-dimensional user data. The user data is distributed across various nodes such as terminals, base stations, core networks, and third-party (over the top, OTT) application servers. The OTT (over the top) refers to a service business that utilizes a network of an operator while services are provided by a third party other than the operator. If different parameters for the same machine learning use case from various nodes can be combined and used for model training, the performance of the model will be greatly improved, which is of great significance to model training. However, sharing of multi-domain data from the multiple nodes will bring great challenges to data privacy. The vertical federated learning (VHL) is a multi-node data sharing technology that enables an artificial intelligence system to use local data from the multiple nodes efficiently and accurately under the premise of meeting data privacy, security, and regulatory requirements, and breaks down data silos to achieve cross-domain under the premise of ensuring privacy and security.

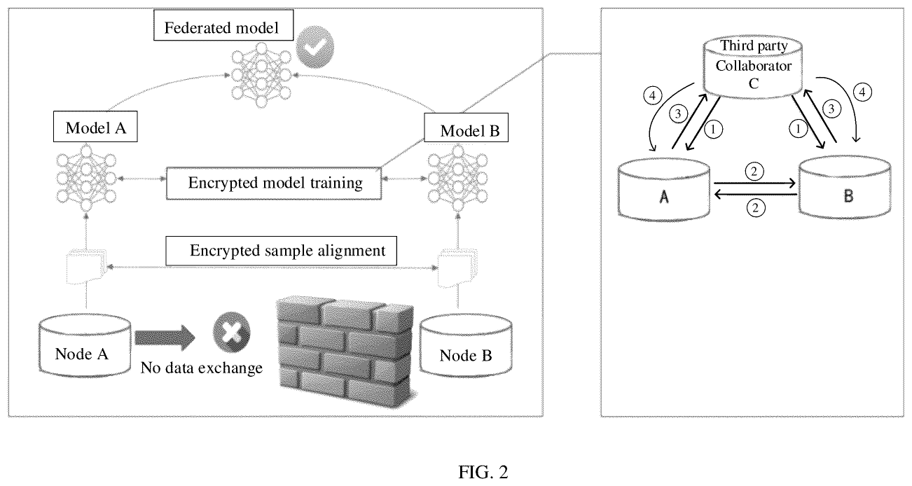

FIG. 2 is a schematic diagram of a training process of a vertical federated learning architecture. As shown in FIG. 2, the training process of the vertical federated learning model is divided into the following steps.
1. Encrypted sample alignment. The vertical federated learning is applicable to situations where participants have a high overlap in training sample identifications (IDs) but a low overlap in data features (for example, different feature data generated by UEs in a certain area at different nodes of the communication system). Therefore, it is necessary to align the samples of participants to increase the feature dimension of each sample without adding the sample ID.
2. Model encryption training for aligned samples, which includes the following steps.
2.1. As shown in the right part of the figure, the third-party collaborator C transmits a public key to A and B, to encrypt the data to be transmitted. The encryption method may adopt homomorphic encryption. That is, the homomorphic encryption is performed on two samples m1 and m2, which is equal to the homomorphic encryption of m1 plus the homomorphic encryption of m2. Homomorphic encryption of sample m multiplied by a constant is equivalent to homomorphic encryption of the sample and then multiplying it by the constant.
2.2. The party that owns labels of the samples is an active party or a demander, e.g., participant B in the figure. A is a data provider (i.e., a passive party), and does not have the labels of the samples. A and B each use their own local data to perform calculations, to obtain intermediate output results of the model. A encrypts the intermediate result and transmits it to B. B calculates the overall output error of the model based on its own label and the model output results of A and B, and the output error is encrypted and then transmitted to A.
2.3. A and B calculate their respective encrypted gradients based on the output error, and transmit them to C after adding masks.
2.4. C decrypts the gradients transmitted by A and B and transmits them back to A and B respectively. A and B remove the masks and update their respective models based on the gradients.

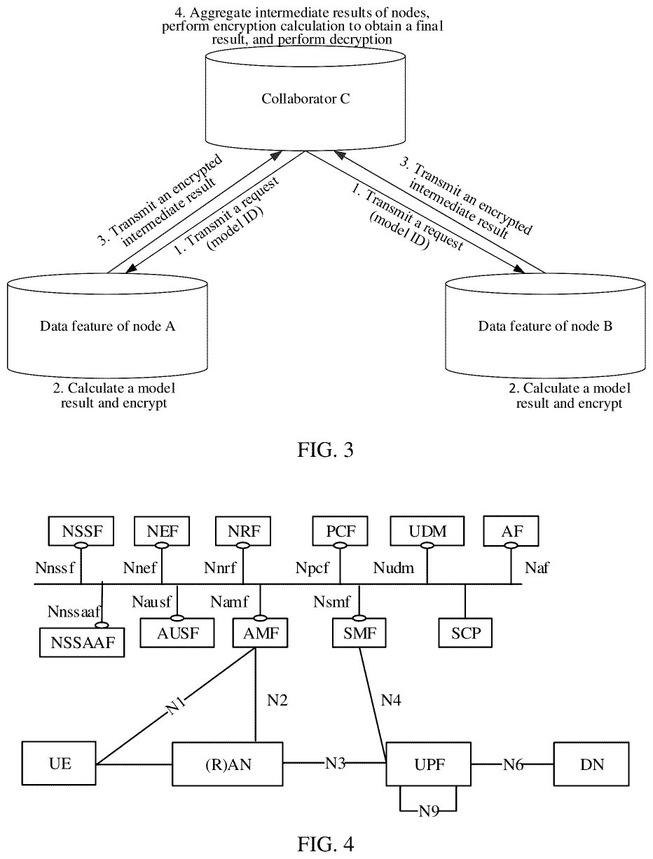

FIG. 3 is a schematic diagram of an inference process of a vertical federated learning architecture. As shown in FIG. 3, the inference process of the vertical federated learning model is divided into the following steps.
1. The collaborator transmits, to node A and node B, a model inference request, including indicating model IDs that A and B need to adopt.
2. Node A and node B perform calculations based on their own data and locally stored models to obtain intermediate results.
3. A and B encrypt the intermediate results and transmit them to collaborator C.
4. C aggregates the intermediate results of node A and node B, performs encryption calculation to obtain a final model inference result, and performs decryption. The inference result can be transmitted to B.
   II. 5th-Generation Mobile Communication Technology (5G) Network Architecture:

a characteristic of the 5G network architecture is service-oriented architecture, which means that a core network element (i.e., a service provider) can provide specific services and make them available to other network elements (i.e., consumers) through defined application programming interfaces (APIs).

FIG. 4 is a schematic diagram of a 5G network structure. As shown in FIG. 4, a UE and a base station establish an access stratum (AS) connection, exchange access stratum messages and perform wireless data transmission, and the UE and a mobility management function (AMF) establish a non-access stratum (NAS) connection and exchange NAS messages. The AMF is responsible for managing UE mobility, and a session management function (SMF) is responsible for UE session management. In addition to managing mobility of mobile terminals, the AMF is further responsible for forwarding session management related messages between the UE and the SMF. A policy control function (PCF) is responsible for formulating policies related to the mobility management, session management, and charging of the UE. A user plane function (UPF) is connected to the base station and the external data network for data transmission.

In addition, the 5G network has added network elements such as a network data analytics function (NWDAF) to the core network. This can collect data from various core network elements and network management systems for big data statistics, analysis, or intelligent data analysis, and obtain network-side analysis or prediction data, thereby assisting various network elements in more effectively controlling UE access based on the data analysis results.

In related technologies, there are multiple usage scenarios in cross-domain vertical federated learning supported by the network architecture. For example, by collecting parameters from different domains, more accurate quality of experience (QoE) is calculated, predicted, or determined. Alternatively, by collecting parameters from different domains, the energy efficiency (EE) of the entire communication system is analyzed, calculated, or predicted, thereby improving the EE. These machine learning use cases all require the collection of different data from multiple domains. Therefore, how to ensure that the neural network model (e.g., the vertical federated learning) may accurately collect data corresponding to the same machine learning use case and distributed in different domains or different nodes during the training or inference process, so as to successfully execute the training or inference of the neural network module (e.g., execute the vertical federated learning), is a problem that needs to be solved. The domain described here may include a UE, a radio access network (RAN), a 5G core network (5G Core, 5GC), an operation administration and maintenance (OAM) network element, or an application.

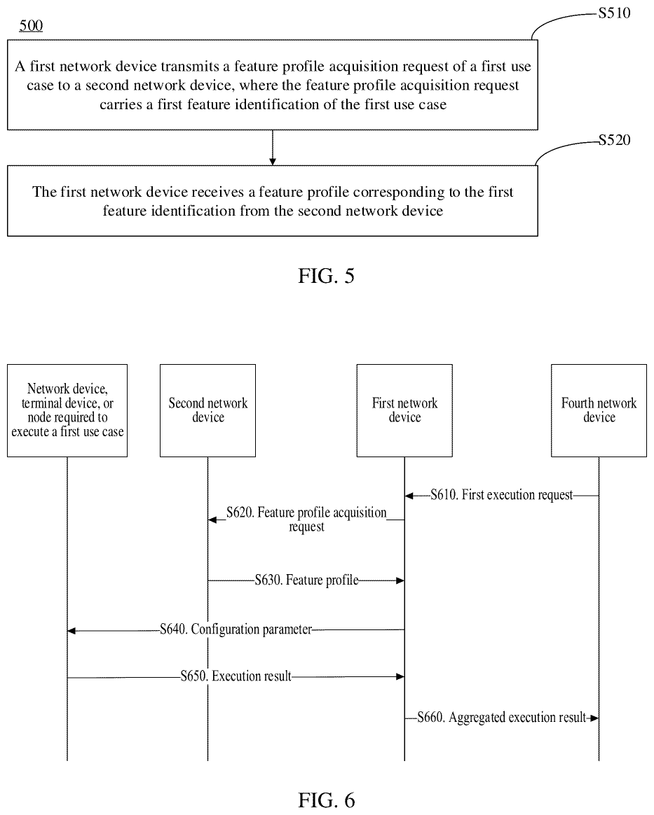

FIG. 5 is a schematic flowchart of a communication method 500 according to an embodiment of the present application. This method can optionally be applied to any one of the systems shown in FIGS. 1 to 4, but is not limited thereto. The method includes at least part of the following contents.

In S510, a first network device transmits a feature profile acquisition request of a first use case to a second network device, where the feature profile acquisition request carries a first feature identification of the first use case.

In S520, the first network device receives a feature profile corresponding to the first feature identification from the second network device.

In some implementations, the first network device includes a network exposure function (NEF).

In some implementations, the second network device includes a unified data management (UDM) or a unified data repository (UDR).

Neural network models have diverse use cases. Taking VFL as an example, types of use cases for the VFL include: statistics and/or prediction of quality of experience (QoE), statistics and/or prediction of energy efficiency (EE), etc. In order to enable the communication network to accurately identify different first use cases and then perform different operations, the embodiments of the present application define an identification of the first use case, which is referred to as a first feature identification (feature ID) in the embodiments of the present application. The first feature identification (feature ID) can be used to distinguish different first use cases.

The first feature identification of the first use case may indicate at least one of:
(1) a type of the first use case; or
(2) an operation for executing the first use case.

The type of the first use case may include at least: statistics and/or prediction of QoE, or statistics and/or prediction of EE.

The operation for executing the first use case may include: a VFL operation.

When a third-party device (e.g., an application function (AF) network element) requests the communication network to execute related operations, a second feature identification may be used. The aforementioned first feature identification may be considered as an internal feature identification used within the communication network, and the second feature identification may be considered as an external feature identification used outside the communication network. There is a mapping relationship between the first feature identification and the second feature identification. When a device (e.g., the AF) outside the communication network requests the communication network to execute related operations, the second feature identification may be used to obtain a corresponding feature profile; after receiving the second feature identification, a device inside the communication network determines the first feature identification corresponding to the second feature identification based on the mapping relationship, and then uses the first feature identifier to obtain the corresponding feature profile. Different feature identifications are set to execute the first use case, and different feature identifications are used inside and outside the communication network, which is conducive to protecting privacy and security.

The feature profile may also be referred to as feature configuration or feature file. The feature profile is associated with the first feature identification and may be used to describe parameter(s) required for the feature and related operations that need to be executed. The first network device uses the first feature identification of the first use case to obtain the feature profile of the first use case, and the first network device uses the feature profile to determine that from which nodes relevant data of the first use case is obtained, thereby achieving collection of parameters of different domains or different nodes according to different use cases, and meeting data requirements during the training and/or execution of machine learning.

In some implementations, parameter(s) included in the feature profile of the first use case include at least one of the following feature parameters:
(1) a type of a parameter that needs to be collected for the first use case;
(2) a model to be adopted for the first use case;
(3) a network element and/or a node that need to be invoked by the first use case;
(4) a time window and/or an area required by the first use case;
(5) an identification of a terminal device involved in the first use case; or
(6) an identification of an application that initiates the first use case.

Specifically, at least one of the following may be included:
(1) the type of the parameter that needs to be collected for executing the use case, where the type of the parameter may be represented by a dataset ID.
(2) the model that needs to be adopted, which refers to a model that needs to be adopted by nodes in various domains for executing the same VFL use case.
(3) the network elements and the nodes that need to be invoked, which refers to network elements and nodes involved in executing a VFL use case. For example, the execution of statistics and/or prediction of the QoE may require an SMF, a PCF, an NWDAF and other network elements, and may also require the participation of nodes such as a gNB and a UE.
(4) the time window and the area for executing the AI operation, which refers to a time window required to execute the VFL use case and an area to which the use case is applicable, where an area of interest (AOI) may be used to represent the area.
(5) UE ID, which refers to a UE involved in the use case.
(6) application ID, which refers to an application that initiates the VFL.

The communication method involved in the embodiments of the present application involves multiple devices. The functions of the multiple devices and the interaction between the devices are introduced below. FIG. 6 is a schematic flowchart of a communication method 600 according to an embodiment of the present application. This method can optionally be applied to any one of the systems shown in FIGS. 1 to 4, but is not limited thereto. In an example shown in FIG. 6, a first network device may include an NEF, a second network device may include a UDM or a UDR, a third network device may include an NWDAF, and a fourth network device may include an AF.

As shown in FIG. 6, the method includes at least part of the following contents.

In S610, the fourth network device transmits a first execution request to the first network device, where the first execution request includes a feature identification of a first use case. The feature identification may be a first feature identification or a second feature identification. If the feature identification is the first feature identification, it means that the same identification is used both inside and outside the communication network without distinguishing between internal and external identifications; if the feature identification is the second feature identification, it means that different identifications are used both inside and outside the communication network.

The first execution request may include a machine learning execution request, e.g., a VFL execution request.

The first execution request further includes at least one of: an identification of a terminal device involved in the first use case, an identification of an application that executes the first use case, or model data required to execute the first use case.

In S620, the first network device receives the first execution request. If the first execution request includes the second feature identification of the first use case, the first network device determines the first feature identification corresponding to the second feature identification. For example, the first network device determines the first feature identification corresponding to the second feature identification based on a preset mapping rule or mapping relationship.

The first network device transmits a feature profile acquisition request of the first use case to the second network device. The feature profile acquisition request carries the first feature identification of the first use case.

In S630, the second network device pre-stores a corresponding relationship between the first feature identification and a feature profile; the second network device can determine the feature profile corresponding to the first feature identification based on the corresponding relationship; and the second network device transmits the feature profile corresponding to the first feature identification to the first network device. The relevant contents of the feature identification and feature profile have been introduced above and will not be repeated here.

In S640, the first network device determines at least one of a network device, a terminal device, or a node required to execute the first use case based on the feature profile. The network device required to execute the first use case may include a core network element, such as a location management function (LMF), a management data analytics function (MDAF), or an NWDAF.

The first network device transmits a configuration parameter in the feature profile to the at least one of the network device, the terminal device, or the node required to execute the first use case.

In S650, the first network device receives execution result(s) of the first use case from the at least one of the network device, the terminal device or the node required to execute the first use case, where an execution result includes the first feature identification of the first use case. The execution result may further include at least one of: a type of a parameter that needs to be collected for the first use case, or a time window and/or an area required by the first use case. The first network device aggregates the received multiple execution results based on the first feature identification included in each execution result. For example, the first network device may aggregate execution results with the same first feature identification, thereby achieving the integration of data for the same first use case.

In S660, the first network device transmits the aggregated execution result to the fourth network device.

The aggregated execution result includes the first feature identification or second feature identification of the first use case. The second feature identification is determined by the first network device based on the first feature identification. For example, the first network device determines the second feature identification corresponding to the first feature identification received in step S650 based on a preset mapping rule or mapping relationship.

The aggregated execution result may further include at least one of: a type of a parameter that needs to be collected for the first use case, or a time window and/or an area required by the first use case.

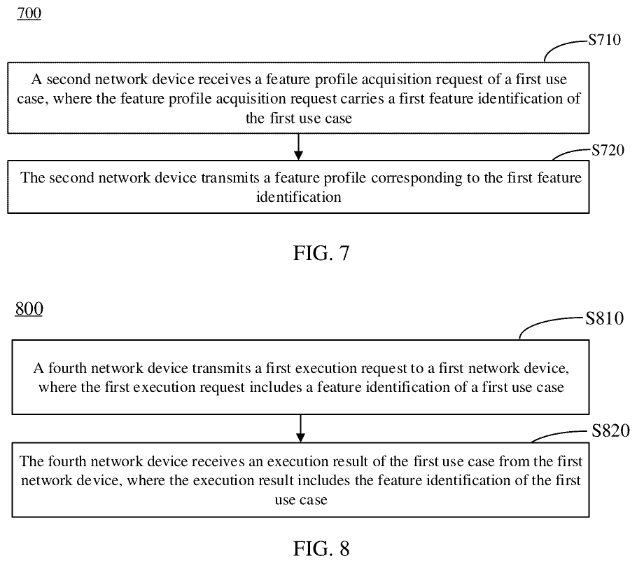

The present application further proposes a communication method, which can be executed by a second network device. The second network device may include a UDM or a UDR. FIG. 7 is a schematic flowchart of a communication method 700 according to an embodiment of the present application. This method can optionally be applied to any one of the systems shown in FIGS. 1 to 4, but is not limited thereto. The method includes as follows.

In S710, a second network device receives a feature profile acquisition request of a first use case, where the feature profile acquisition request carries a first feature identification of the first use case.

In S720, the second network device transmits a feature profile corresponding to the first feature identification.

In some implementations, the second network device may receive the feature profile acquisition request from a first network device, and transmit the feature profile to the first network device. The first network device may include an NEF.

When the second network device receives the request carrying the first feature identification of the first use case from the first network device, the second network device feeds back the feature profile of the first use case to the first network device; the first network device may use the feature profile to determine that from which nodes relevant data of the first use case is obtained, thereby achieving collection of parameters of different domains or different nodes according to different use cases, and meeting data requirements during the training and/or execution of machine learning.

In some implementations, the feature profile of the first use case includes at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

The type of the first use case may include at least one of: statistics and/or prediction of QoE; or statistics and/or prediction of EE.

The operation for executing the first use case may include: a VFL operation.

In some implementations, the second network device stores the feature profile corresponding to the first feature identification. According to the aforementioned information stored in advance, after receiving the feature profile acquisition request, the second network device can search for the feature profile corresponding to the first feature identification based on the first feature identification of the first use case carried in the feature profile acquisition request, and can feed back the feature profile to the first network device.

For other execution steps of the second network device, reference may be made to the relevant content of the second network device in the example of FIG. 6, which will not be repeated here.

The present application further proposes a communication method, which can be executed by a fourth network device. The fourth network device may include an AF. FIG. 8 is a schematic flowchart of a communication method 800 according to an embodiment of the present application. This method can optionally be applied to any one of the systems shown in FIGS. 1 to 4, but is not limited thereto. The method includes as follows.

In S810, a fourth network device transmits a first execution request to a first network device, where the first execution request includes a feature identification of a first use case.

In S820, the fourth network device receives an execution result of the first use case from the first network device, where the execution result includes the feature identification of the first use case.

By setting the feature identification for the first use case, the fourth network device obtains the execution result of the first use case based on the feature identification of the first use case. Thus, the parameters of the first use case in different domains or different nodes can be obtained, thereby meeting the data requirements during the training and/or execution of machine learning.

The first network device may include an NEF.

In some implementations, the first execution request further includes at least one of:
an identification of a terminal device involved in the first use case;
an identification of an application that executes the first use case; or
model data required to execute the first use case.

A type of a parameter is represented by a dataset ID.

In some implementations, the first use case may include a VFL use case.

In some implementations, the feature identification of the first use case may be a first feature identification or a second feature identification. The specific content of the first feature identification or the second feature identification may refer to the aforementioned related content and will not be repeated here.

In some implementations, the feature identification indicates at least one of:
a type of the first use case; or
an operation for executing the first use case.

The type of the first use case may include at least one of: statistics and/or prediction of quality of experience (QoE); or statistics and/or prediction of energy efficiency (EE).

The operation for executing the first use case may include: a VFL operation.

For other execution steps of the fourth network device, reference may be made to the relevant content of the fourth network device in the example of FIG. 6, which will not be repeated here.

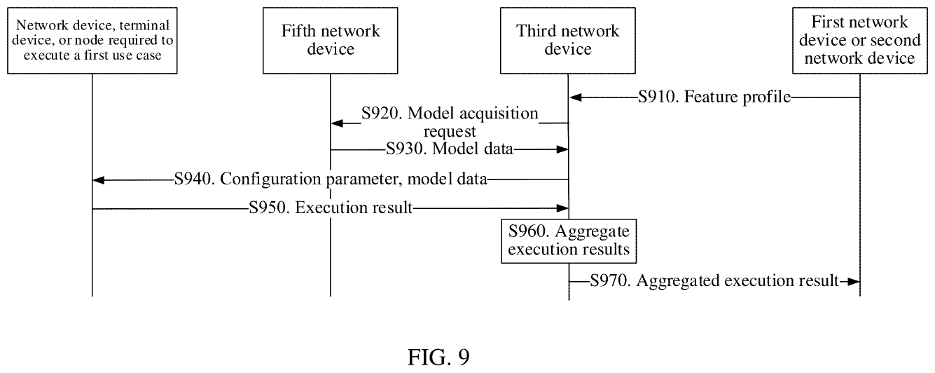

The embodiments of the present application further propose another communication method, which involves multiple devices. The functions of the multiple devices and the interaction between the devices are introduced below. FIG. 9 is a schematic flowchart of a communication method 900 according to an embodiment of the present application. This method can optionally be applied to any one of the systems shown in FIGS. 1 to 4, but is not limited thereto. In an example shown in FIG. 9, a first network device may include an NEF, a second network device may include a UDM or a UDR, a third network device may include an NWDAF, a fourth network device may include an AF, and a fifth network device may include an analytics data repository function (ADRF).

As shown in FIG. 9, the method includes at least part of the following contents.

In S910, the third network device receives a feature profile of a first use case.

For example, if data aggregation is initiated by the first network device, the third network device may receive the feature profile of the first use case or a configuration parameter included in the feature profile from the first network device. Specifically, after receiving a first execution request, the first network device may transmit the feature profile or the configuration parameter included in the feature profile to the third network device.

For another example, if data aggregation is initiated by the third network device, the third network device may transmit a feature profile acquisition request of the first use case to the second network device, where the feature profile acquisition request carries a first feature identification of the first use case; and the third network device receives the feature profile of the first use case (i.e., the feature profile corresponding to the first feature identification) from the second network device.

The relevant contents of the first feature identification and the feature profile have been introduced in the above content and will not be repeated here.

In S920, the third network device determines required model data based on the feature profile, and transmits a model acquisition request to the fifth network device, where the model acquisition request carries a model ID. The fifth network device may store model data of multiple models in advance.

In S930, the third network device receives model data of the model from the fifth network device.

In S940, the third network device determines a network device, a terminal device and/or a node required to execute the first use case based on the feature profile, and transmits a configuration parameter, a model parameter and other information in the feature profile to the network device, the terminal device and/or the node required to execute the first use case.

In S950, the network device, the terminal device and/or the node required to execute the first use case execute the first use case based on the received configuration parameter, model parameter and other information, and feed back execution result(s) of the first use case to the third network device respectively. The execution result may include the first feature identification of the first use case. The execution result may further include at least one of: a type of a parameter that needs to be collected for the first use case; or a time window and/or an area required by the first use case.

In S960, the third network device aggregates the received multiple execution results based on the first feature identification included in the execution result. If the data aggregation is initiated by the third network device, the current process ends. If the data aggregation is initiated by the first network device, proceed to step S970.

In S970, the third network device transmits the aggregated execution result to the first network device.

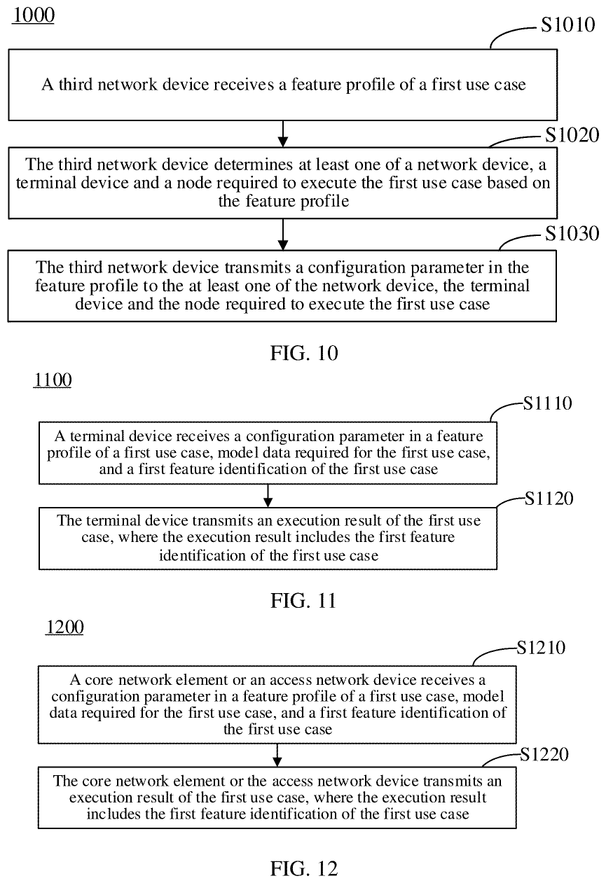

The present application further proposes a communication method, which can be executed by a third network device. The third network device may include an NWDAF. FIG. 10 is a schematic flowchart of a communication method 1000 according to an embodiment of the present application. This method can optionally be applied to any one of the systems shown in FIGS. 1 to 4, but is not limited thereto. The method includes as follows.

In S1010, a third network device receives a feature profile of a first use case.

In S1020, the third network device determines at least one of a network device, a terminal device or a node required to execute the first use case based on the feature profile.

In S1030, the third network device transmits a configuration parameter in the feature profile to the at least one of the network device, the terminal device or the node required to execute the first use case.

Based on the feature profile of the first use case, the third network device determines various nodes that execute the first use case, and thus obtains relevant data of the first use case from the nodes, thereby achieving collection of parameters of the first use case in different domains or different nodes, and meeting data requirements during the training and/or execution of machine learning.

In some implementations, the method further includes that: the third network device obtains model data required for the first use case from a fifth network device based on the feature profile of the first use case; and the third network device transmits the model data required for the first use case to at least one of the network device, the terminal device or the node required to execute the first use case.

The fifth network device may include an ADRF.

In some implementations, the method further includes that: the third network device receives execution result(s) of the first use case from at least one of the network device, the terminal device or the node required to execute the first use case, where an execution result includes a first feature identification of the first use case; and the third network device aggregates the received multiple execution results based on the first feature identification included in the execution result.

The execution result may further include at least one of:
a type of a parameter that needs to be collected for the first use case; or
a time window and/or an area required by the first use case.

In some implementations, the method further includes that the third network device transmits the aggregated execution result to a first network device. The first network device may include an NEF.

In some implementations, the feature profile of the first use case includes at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

The type of the parameter may be represented by a dataset ID.

In some implementations, the first use case includes a VFL use case.

In some implementations, the first feature identification indicates at least one of: a type of the first use case; or an operation for executing the first use case.

In some embodiments, the type of the first use case includes at least one of: statistics and/or prediction of QoE; or statistics and/or prediction of EE.

The operation for executing the first use case may include: a VFL operation.

For other execution steps of the second network device, reference may be made to the relevant content of the third network device in the examples of FIGS. 6 and 9, which will not be repeated here.

The embodiments of the present application further propose a communication method, which can be executed by a terminal device. FIG. 11 is a schematic flowchart of a communication method 1100 according to an embodiment of the present application. This method can optionally be applied to any one of the systems shown in FIGS. 1 to 4, but is not limited thereto. The method includes as follows.

In S1110, a terminal device receives a configuration parameter in a feature profile of a first use case, model data required for the first use case, and a first feature identification of the first use case.

In S1120, the terminal device transmits an execution result of the first use case, where the execution result includes the first feature identification of the first use case.

After executing the first use case, the terminal device may mark the execution result of the first use case with a corresponding identification by including the first feature identification of the first use case in the execution result of the first use case, so that the device receiving the execution result may collect parameters belonging to the same first use case based on the first feature identification, thereby meeting data requirements during the training and/or execution of machine learning.

In some implementations, the execution result further includes at least one of:
a type of a parameter that needs to be collected for the first use case; or
a time window and/or an area required by the first use case.

In some implementations, the type of the parameter is represented by a dataset ID.

In some implementations, the first use case includes a VFL use case.

In some implementations, the first feature identification indicates at least one of: a type of the first use case; or an operation for executing the first use case.

In some implementations, the type of the first use case includes at least one of: statistics and/or prediction of QoE; or statistics and/or prediction of EE.

In some implementations, the operation for executing the first use case include: a VFL operation.

For other execution steps of the terminal device, reference may be made to the relevant content of the terminal device in the examples of FIGS. 6 and 9, which will not be repeated here.

The embodiments of the present application further propose a communication method, which can be executed by a core network element or an access network device. FIG. 12 is a schematic flowchart of a communication method 1200 according to an embodiment of the present application. This method can optionally be applied to any one of the systems shown in FIGS. 1 to 4, but is not limited thereto. The method includes as follows.

In S1210, a core network element or an access network device receives a configuration parameter in a feature profile of a first use case, model data required for the first use case, and a first feature identification of the first use case.

In S1220, the core network element or the access network device transmits an execution result of the first use case, where the execution result includes the first feature identification of the first use case.

After executing the first use case, the core network element or the access network device may mark the execution result of the first use case with a corresponding identification by including the first feature identification of the first use case in the execution result of the first use case, so that the device receiving the execution result may collect parameters belonging to the same first use case based on the first feature identification, thereby meeting data requirements during the training and/or execution of machine learning.

In some implementations, the execution result further includes at least one of:
a type of a parameter that needs to be collected for the first use case; or
a time window and/or an area required by the first use case.

In some implementations, the type of the parameter is represented by a dataset ID.

In some implementations, the first use case includes a VFL use case.

In some implementations, the first feature identification indicates at least one of: a type of the first use case, or an operation for executing the first use case.

In some embodiments, the type of the first use case includes at least one of: statistics and/or prediction of QoE; or statistics and/or prediction of EE.

In some implementations, the operation for executing the first use case includes: a VFL operation.

For other execution steps of the terminal device, reference may be made to the relevant content of the network device or node required to execute the first use case in the examples of FIGS. 6 and 9, which will not be repeated here.

Specific embodiments are described in detail below with reference to the accompanying drawings.

The following embodiments are introduced by taking an example where the first network device is specifically an NEF, the second network device is specifically a UDM or a UDR, the third network device is specifically an NWDAF, the fourth network device is an AF, and the fifth network device is specifically an ADRF. In other embodiments of the present application, the aforementioned network devices may also be other functional network elements. Furthermore, in the following embodiments, the first use case is specifically taken as a VFL use case for example. In other embodiments of the present application, the first use case may also be another use case.

### Embodiment 1

The VFL has diverse use cases, such as statistics and/or prediction of QoE, and statistics and/or prediction of EE. In order to enable the communication network to accurately identify different use cases and then perform different operations, the embodiment defines a new ID (i.e., a feature ID) to distinguish different use cases. The information that the feature ID may reflect is as follows:
(1) an executed use case, such as prediction and statistics of the QoE, or statistics of energy efficiency; and
(2) an AI operation for executing the use case: VFL.

When the third party requests the communication network to execute related operations through a feature ID, there may also be a mapping relationship between an external feature ID and an internal feature ID.

The embodiment of the present application further defines a feature profile associated with the feature ID to describe parameters required for the feature and related operations that need to be executed. The parameters included in the feature profile are as follows:
(1) a type of a parameter that needs to be collected for executing the use case, where the type of the parameter may be represented by a dataset ID.
(2) a model that needs to be adopted, which refers to a model that needs to be adopted by nodes in various domains for executing the same VFL use case.
(3) network elements and nodes that need to be invoked: network elements and nodes involved in executing a VFL use case. For example, the execution of the QoE may require an SMF, a PCF, an NWDAF and other network elements, and may also require the participation of nodes such as a gNB and a UE.
(4) a time window and an area for executing the AI operation, which refers to a time window required to execute the VFL use case and an area to which the use case is applicable, where AOI may be used to represent the area.
(5) UE ID: a UE involved in the use case.
(6) application ID: an application that initiates the VFL.

### Embodiment 2

In this embodiment, an AF initiates a VFL execution request, and a model required for executing the VFL is directly transmitted through the AF.

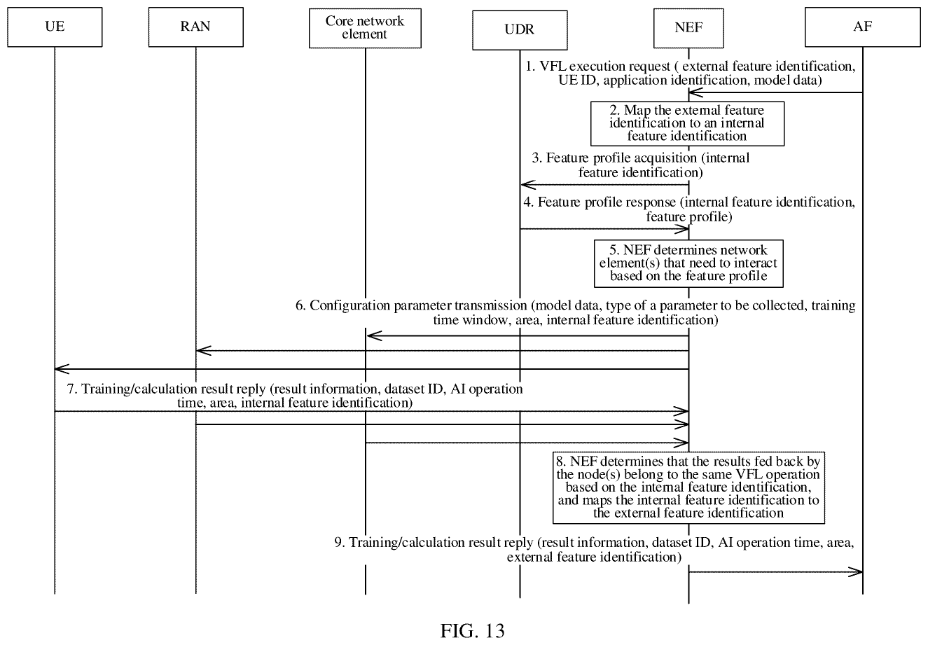

FIG. 13 is an implementation flowchart of Embodiment 2 of the present application, which includes the following steps.

In step 1, when a third-party AF requests to execute a VFL use case, the AF transmits a VFL execution request to an NEF. The VFL execution request includes a second feature identification (which is referred to as an external feature ID), and the second feature identification indicates the VFL use case that the AF requests to execute. For example, the second feature identification indicates that a type of the VFL use case is statistics and/or prediction of QoE. The VFL execution request may further include a UE identification (UE ID), an application identification (application ID), and model data required to execute the VFL use case. The UE identification indicates a UE involved in executing the VFL use case, and the application identification indicates an application corresponding to the execution of the VFL use case.

In step 2, the NEF maps the second feature identification to a first feature identification (which is referred to as an internal feature ID) used within the communication network based on the UE identification, the application identification and other information.

In step 3, after receiving the request, the NEF transmits a feature profile acquisition request to a unified data repository (UDR) based on the first feature identification.

In step 4, the UDR feeds back a pre-stored feature profile corresponding to the first feature identification to the NEF. Details of parameters included in the feature profile may refer to Embodiment 1.

In step 5, the NEF determines at least one of a network element, an RAN, or a UE that needs to interact based on the received feature profile.

In step 6, the NEF transmits configuration parameters in the feature profile to the at least one of the network element, RAN, or UE that is determined, where the configuration parameters mainly include the first feature identification, model data required to execute the VFL use case, a type of a parameter to be collected as model input, a time window for executing the AI operation (including training and/or inference), area information where the UE and/or RAN is located when executing the VFL use case, and service area information of each network element when executing the VFL use case.

In step 7, the node(s) (including the at least one of the network element, RAN, or UE) transmit results obtained after completing the AI operation to the NEF. The result includes the first feature identification, result information, the type of the parameter (represented by a dataset ID), time for executing the AI operation, area information, etc. The dataset ID is used to indicate a form of the dataset used by each node when performing the AI operation locally, such as a distribution feature, a sampling feature, or a sample dimension.

In step 8, the NEF determines that the results fed back by the node(s) belong to the same VFL operation based on the first feature identification in the information collected from each node. The NEF may aggregate information with the same first feature identification. Furthermore, the NEF maps the first feature identification to the second feature identification.

In step 9, the NEF replies the result of the AI operation to the AF. The message includes the result information or aggregated result information, the type of the parameter (indicated by the dataset ID), the time for executing the AI operation, the area information, the second feature identification, etc.

### Embodiment 3

In this embodiment, an AF initiates a VFL execution request, and a model required for executing the VFL is pre-stored in the analytic data repository function (ADRF).

Compared with Embodiment 2, in this embodiment, the AF does not directly provide the model data, but the model is stored in the ADRF of the core network in advance. For example, the relevant VFL has been executed before, or the AF and the core network element have negotiated before requesting the execution of the operation and the model is pre-stored in the ADRF.

FIG. 14 is an implementation flowchart of Embodiment 3 of the present application, which includes the following steps.

In step 1, when a third-party AF requests to execute a VFL use case, the AF transmits a VFL execution request to an NEF. The VFL execution request includes a second feature identification (which is referred to as an external feature ID), and the second feature identification indicates the VFL use case that the AF requests to execute. For example, the second feature identification indicates that a type of the VFL use case is statistics and/or prediction of QoE. The VFL execution request may further include a UE identification (UE ID) and an application identification (application ID). The UE identification indicates a UE involved in executing the VFL use case, and the application identification indicates an application corresponding to the execution of the VFL use case.

In step 2, the NEF maps the second feature identification to a first feature identification (which is referred to as an internal feature ID) used within the communication network based on the UE identification, the application identification and other information.

In step 3, after receiving the request, the NEF transmits a feature profile acquisition request to a unified data repository (UDR) based on the first feature identification.

In step 4, the UDR feeds back a pre-stored feature profile corresponding to the first feature identification to the NEF. Details of parameters included in the feature profile may refer to Embodiment 1.

In step 5, the NEF determines an NWDAF that can interact with an ADRF based on the received feature profile.

In step 6, the NEF transmits the first feature identification and the corresponding feature profile to the NWDAF.

In step 7, the NWDAF interacts with the ADRF based on the instruction of the required model in the feature profile to obtain the required model. Specifically, the NWDAF may transmit a model acquisition message to the ADRF, where the message includes an ID of the required model.

In step 8, the ADRF feeds back data of the model that meets the requirements to the NWDAF.

In step 9, the NWDAF transmits configuration parameters in the feature profile to at least one of a corresponding network element, RAN, or UE, where the configuration parameters mainly include the first feature identification, model data required to execute the VFL use case, a type of a parameter that needs to be collected as model input, a time window for executing the AI operation (including training and/or inference), area information where the UE and/or RAN is located when executing the VFL use case, and service area information of each network element when executing the VFL use case.

In step 10, the node(s) (including the at least one of the network element, RAN, or UE) transmits results obtained after completing the AI operation to the NWDAF. The result includes the first feature identification, result information, the type of the parameter (represented by a dataset ID), time for executing the AI operation, area information, etc. The dataset ID is used to indicate a form of the dataset used by each node when performing the AI operation locally, such as a distribution feature, a sampling feature, or a sample dimension.

In step 11, the NWDAF determines that the results fed back by the node(s) belong to the same VFL operation based on the first feature identification in the information collected from each node. The NWDAF may aggregate information with the same first feature identification.

In step 12, the NWDAF transmits the aggregated result to the NEF.

In step 13, the NEF maps the first feature identification to the second feature identification.

In step 14, the NEF replies the result of the AI operation to the AF. The message includes the result information or aggregated result information, the type of the parameter (indicated by the dataset ID), the time for executing the AI operation, the area information, the second feature identification, etc.

### Embodiment 4

In this embodiment, an NWDAF initiates a VFL process.

The difference from Embodiment 2 and Embodiment 3 is that in this embodiment, the VFL operation is initiated by a network element of the core network, e.g., the NWDAF. Therefore, the participation of the NEF is not required, and the mapping of feature identifications is also not required.

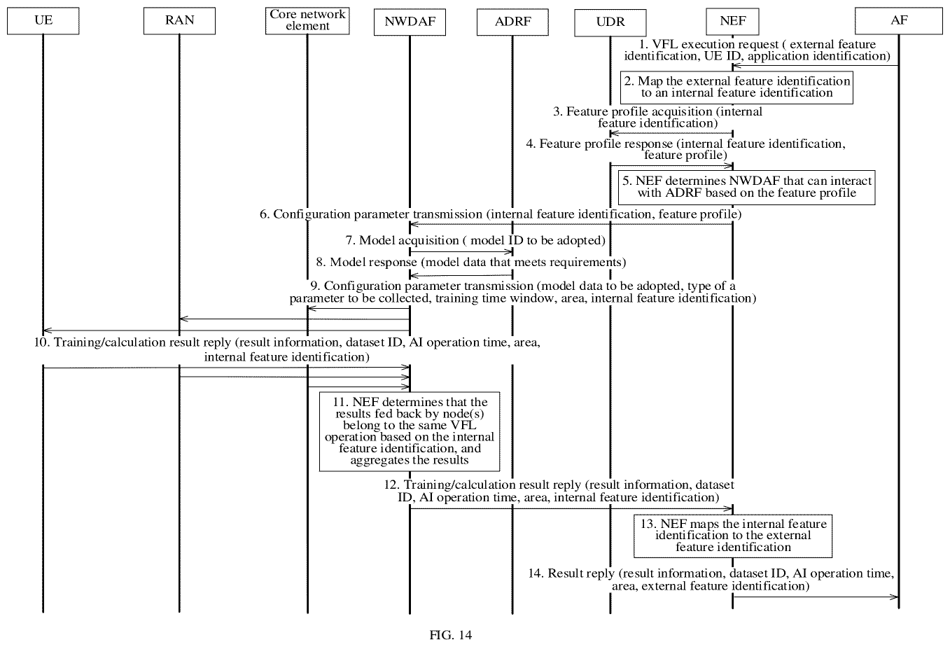

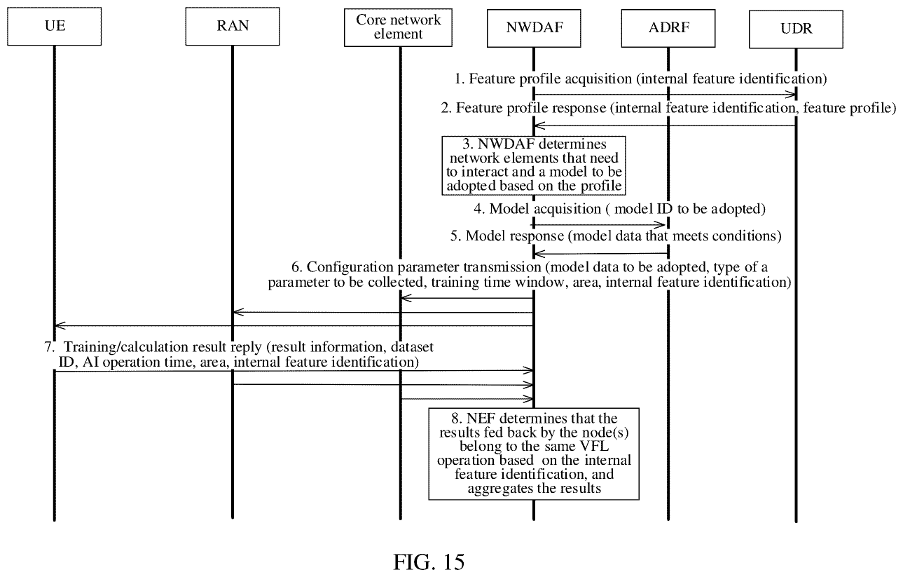

FIG. 15 is an implementation flowchart of Embodiment 4 of the present application, which includes the following steps.

In step 1, when an NWDAF requests to execute VFL, the NWDAF transmits a feature profile acquisition request to a UDR. The feature profile includes a first feature identification.

In step 2, the UDR feeds back a pre-stored feature profile corresponding to the first feature identification to the NWDAF. Details of parameters included in the feature profile may refer to Embodiment 1.

In step 3, the NWDAF determines a model to be adopted based on the indication of the required model included in the feature profile.

In step 4, the NWDAF interacts with an ADRF to obtain the required model. Specifically, the NWDAF may transmit a model acquisition message to the ADRF, where the message includes an ID of the required model.

In step 5, the ADRF feeds back data of the model that meets the requirements to the NWDAF.

In step 6, the NWDAF transmits configuration parameters in the feature profile to at least one of a corresponding network element, RAN, or UE, where the configuration parameters mainly include the first feature identification, model data required to execute the VFL use case, a type of a parameter that needs to be collected as model input, a time window for executing the AI operation (including training and/or inference), area information where the UE and/or RAN is located when executing the VFL use case, and service area information of each network element when executing the VFL use case.

In step 7, the node(s) (including the at least one of the network element, RAN, or UE) transmits results obtained after completing the AI operation to the NWDAF. The result includes the first feature identification, result information, the type of the parameter (represented by a dataset ID), time for executing the AI operation, area information, etc. The dataset ID is used to indicate a form of the dataset used by each node when performing the AI operation locally, such as a distribution feature, a sampling feature, or a sample dimension.

In step 8, the NWDAF determines that the results fed back by the node(s) belong to the same VFL operation based on the first feature identification in the information collected from each node. The NWDAF may aggregate information with the same first feature identification.

In the technical solutions, how to use feature representation and invoke the related feature profile is introduced when multi-domain VFL is executed, so that the execution node can know which network elements, RANs, UEs can be collaborated to obtain the information, so as to successfully perform the VFL operation. The solutions provide specific execution processes for two different scenarios: the third party initiates the VFL and the core network element initiates the NWDAF. It implements the support for the VFL by the communication system and may meet the requirements of use cases such as statistics and/or prediction of QoE, and statistics and/or prediction of EE.

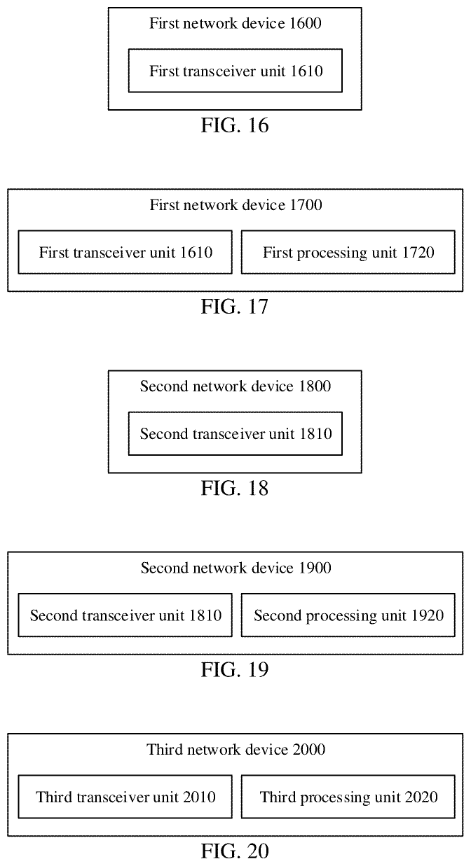

The embodiments of the present application further propose a first network device. FIG. 16 is a schematic block diagram of a first network device 1600 according to an embodiment of the present application. The first network device 1600 may include:
a first transceiver unit 1610, configured to: transmit a feature profile acquisition request of a first use case to a second network device, where the feature profile acquisition request carries a first feature identification of the first use case; and receive a feature profile corresponding to the first feature identification from the second network device.

In some implementations, the feature profile of the first use case includes at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of energy efficiency (EE).

In some implementations, the operation for executing the first use case include: a VFL operation.

In some implementations, the first transceiver unit 1610 is further configured to receive a first execution request from a fourth network device, where the first execution request includes a feature identification of the first use case.

In some implementations, the first execution request further includes at least one of:
an identification of a terminal device involved in the first use case;
an identification of an application that executes the first use case; or
model data required to execute the first use case.

In some implementations, the feature identification of the first use case includes the first feature identification of the first use case.

In some implementations, the feature identification of the first use case includes a second feature identification of the first use case.

The embodiments of the present application further propose a first network device. FIG. 17 is a schematic block diagram of a first network device 1700 according to an embodiment of the present application. The first network device 1700 may further include:
a first processing unit 1720, configured to determine a first feature identification corresponding to the second feature identification.

In some implementations, the first processing unit 1720 is further configured to determine at least one of a network device, a terminal device, or a node required to execute the first use case based on the feature profile.

The first transceiver unit 1610 is further configured to transmit a configuration parameter in the feature profile to the at least one of the network device, terminal device, or node required to execute the first use case.

In some implementations, the first transceiver unit 1610 is further configured to receive execution result(s) of the first use case from the at least one of the network device, terminal device or node required to execute the first use case, where an execution result includes the first feature identification of the first use case.

In some implementations, the execution result further includes at least one of:
a type of a parameter that needs to be collected for the first use case; or
a time window and/or an area required by the first use case.

In some implementations, the first processing unit 1720 is further configured to aggregate received multiple execution results based on the first feature identification included in the execution result.

In some implementations, the first transceiver unit 1610 is further configured to transmit the aggregated execution result to a fourth network device.

In some implementations, the aggregated execution result includes the first feature identification or the second feature identification of the first use case.

The second feature identification is determined by the first network device based on the first feature identification.

In some implementations, the aggregated execution result further includes at least one of:
a type of a parameter that needs to be collected for the first use case; or
a time window and/or an area required by the first use case.

In some implementations, the first network device includes an NEF.

In some implementations, the second network device includes a UDM or a UDR.

In some implementations, the fourth network device includes an AF.

In some implementations, the network device required to execute the first use case includes a core network element.

In some implementations, the core network element includes an LMF, an MDAF, or an NWDAF.

The first network device 1600 and the first network device 1700 in the embodiments of the present application can implement the corresponding functions of the first network device in the aforementioned method embodiments. The process, function, implementation and beneficial effects corresponding to each module (e.g., sub-module, unit or component) in the first network device 1600 and the first network device 1700 may refer to the corresponding description in the above method embodiments and will not be repeated here. It should be noted that the functions described with respect to various modules (e.g., sub-modules, units or components) in the first network device 1600 and the first network device 1700 in the embodiments of the present application may be implemented by different modules (e.g., sub-modules, units or components) or implemented by a same module (e.g., sub-module, unit or component).

The embodiments of the present application further propose a second network device. FIG. 18 is a schematic block diagram of a second network device 1800 according to an embodiment of the present application. The second network device 1800 may include:
a second transceiver unit 1810, configured to: receive a feature profile acquisition request of a first use case, where the feature profile acquisition request carries a first feature identification of the first use case; and transmit a feature profile corresponding to the first feature identification.

In some implementations, the feature profile of the first use case includes at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

In some implementations, the type of the parameter is represented by a dataset identification.

The embodiments of the present application further propose a second network device. FIG. 19 is a schematic block diagram of a second network device 1900 according to an embodiment of the present application. The second network device 1900 may include:
a second processing unit 1920, configured to store the feature profile corresponding to the first feature identification.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case includes: a VFL operation.

In some implementations, the second network device includes a UDM or a UDR.

The second network device 1800 and the second network device 1900 in the embodiments of the present application can implement the corresponding functions of the second network device in the aforementioned method embodiments. The process, function, implementation and beneficial effects corresponding to each module (e.g., sub-module, unit or component) in the second network device 1800 and the second network device 1900 may refer to the corresponding description in the above method embodiments and will not be repeated here. It should be noted that the functions described with respect to various modules (e.g., sub-modules, units or components) in the second network device 1800 and the second network device 1900 in the embodiments of the present application may be implemented by different modules (e.g., sub-modules, units or components) or implemented by a same module (e.g., sub-module, unit or component).

The embodiments of the present application further propose a third network device. FIG. 20 is a schematic block diagram of a third network device 2000 according to an embodiment of the present application. The third network device 2000 may include:
a third transceiver unit 2010, configured to receive a feature profile of a first use case; and
a third processing unit 2020, configured to determine at least one of a network device, a terminal device or a node required to execute the first use case based on the feature profile, where
the third transceiver unit 2010 is further configured to transmit a configuration parameter in the feature profile to the at least one of the network device, terminal device, or node required to execute the first use case.

In some implementations, the second processing unit 2020 is further configured to obtain model data required for the first use case from a fifth network device based on the feature profile of the first use case; and
the third transceiver unit 2010 is further configured to transmit the model data required for the first use case to the at least one of the network device, terminal device, or node required to execute the first use case.

In some implementations, the third transceiver unit 2010 is further configured to receive execution result(s) of the first use case from the at least one of the network device, terminal device or node required to execute the first use case, where an execution result includes a first feature identification of the first use case; and
the third processing unit 2020 is further configured to aggregate received multiple execution results based on the first feature identification included in the execution result.

In some implementations, the execution result further includes at least one of:
a type of a parameter that needs to be collected for the first use case; or
a time window and/or an area required by the first use case.

In some implementations, the third transceiver unit 2010 is further configured to transmit the aggregated execution result to a first network device.

In some implementations, the feature profile of the first use case includes at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case include: a VFL operation.

In some implementations, the third network device includes an NWDAF.

In some implementations, the fifth network device includes an ADRF.

In some implementations, the first network device includes a NEF.

The third network device 2000 in the embodiments of the present application can implement the corresponding functions of the third network device in the aforementioned method embodiments. The process, function, implementation and beneficial effects corresponding to each module (e.g., sub-module, unit or component) in the third network device 2000 may refer to the corresponding description in the above method embodiments and will not be repeated here. It should be noted that the functions described with respect to various modules (e.g., sub-modules, units or components) in the third network device 2000 in the embodiments of the present application may be implemented by different modules (e.g., sub-modules, units or components) or implemented by a same module (e.g., sub-module, unit or component).

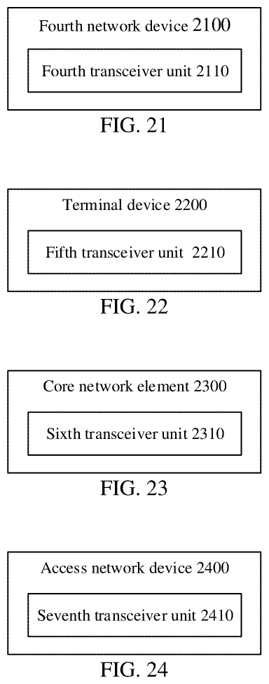

The embodiments of the present application further propose a fourth network device. FIG. 21 is a schematic block diagram of a fourth network device 2100 according to an embodiment of the present application. The fourth network device 2100 may include:
a fourth transceiver unit 2110, configured to: transmit a first execution request to a first network device, where the first execution request includes a feature identification of a first use case; and receive an execution result of the first use case from the first network device, where the execution result includes the feature identification of the first use case.

In some implementations, the first execution request further includes at least one of:
an identification of a terminal device involved in the first use case;
an identification of an application that executes the first use case; or
model data required to execute the first use case.

In some implementations, a type of a parameter is represented by a dataset ID.

In some implementations, the first use case includes a VFL use case.

In some implementations, a first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case includes: a VFL operation.

The fourth network device 2100 in the embodiments of the present application can implement the corresponding functions of the fourth network device in the aforementioned method embodiments. The process, function, implementation and beneficial effects corresponding to each module (e.g., sub-module, unit or component) in the fourth network device 2100 may refer to the corresponding description in the above method embodiments and will not be repeated here. It should be noted that the functions described with respect to various modules (e.g., sub-modules, units or components) in the fourth network device 2100 in the embodiments of the present application may be implemented by different modules (e.g., sub-modules, units or components) or by a same module (e.g., sub-module, unit or component).

The embodiments of the present application further propose a terminal device. FIG. 22 is a schematic block diagram of a terminal device 2200 according to an embodiment of the present application. The terminal device 2200 may include:
a fifth transceiver unit 2210, configured to: receive a configuration parameter in a feature profile of a first use case, model data required for the first use case, and a first feature identification of the first use case; and transmit an execution result of the first use case, where the execution result includes the first feature identification of the first use case.

In some implementations, the execution result further includes at least one of:
a type of a parameter that needs to be collected for the first use case; or
a time window and/or an area required by the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case includes: a VFL operation.

The terminal device 2200 in the embodiments of the present application can implement the corresponding functions of the terminal device in the aforementioned method embodiments. The process, function, implementation and beneficial effects corresponding to each module (e.g., sub-module, unit or component) in the terminal device 2200 may refer to the corresponding description in the above method embodiments and will not be repeated here. It should be noted that the functions described with respect to various modules (e.g., sub-modules, units or components) in the terminal device 2200 in the embodiments of the present application may be implemented by different modules (e.g., sub-modules, units or components) or implemented by a same module (e.g., sub-module, unit or component).

The embodiments of the present application further propose a core network element. FIG. 23 is a schematic block diagram of a core network element 2300 according to an embodiment of the present application. The core network element 2300 may include:
a sixth transceiver unit 2310, configured to: receive a configuration parameter in a feature profile of a first use case, model data required for the first use case, and a first feature identification of the first use case; and transmit an execution result of the first use case, where the execution result includes the first feature identification of the first use case.

In some implementations, the execution result further includes at least one of:
a type of a parameter that needs to be collected for the first use case; or
a time window and/or an area required by the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case include: a VFL operation.

The core network element 2300 in the embodiments of the present application can implement the corresponding functions of the core network element in the aforementioned method embodiments. The process, function, implementation and beneficial effects corresponding to each module (e.g., sub-module, unit or component) in the core network element 2300 may refer to the corresponding description in the above method embodiments and will not be repeated here. It should be noted that the functions described with respect to various modules (e.g., sub-modules, units or components) in the core network element 2300 in the embodiments of the present application may be implemented by different modules (e.g., sub-modules, units or components) or implemented by a same module (e.g., sub-module, unit or component).

The embodiments of the present application further propose an access network device. FIG. 24 is a schematic block diagram of an access network device 2400 according to an embodiment of the present application. The access network device 2400 may include:
a seventh transceiver unit 2410, configured to: receive a configuration parameter in a feature profile of a first use case, model data required for the first use case, and a first feature identification of the first use case; and transmit an execution result of the first use case, where the execution result includes the first feature identification of the first use case.

In some implementations, the execution result further includes at least one of:
a type of a parameter that needs to be collected for the first use case; or
a time window and/or an area required by the first use case.

In some implementations, the type of the parameter is represented by a dataset ID.

In some implementations, the first use case includes a VFL use case.

In some implementations, the first feature identification indicates at least one of:
a type of the first use case; or
an operation for executing the first use case.

In some implementations, the type of the first use case includes at least one of:
statistics and/or prediction of user QoE; or
statistics and/or prediction of EE.

In some implementations, the operation for executing the first use case includes: a VFL operation.

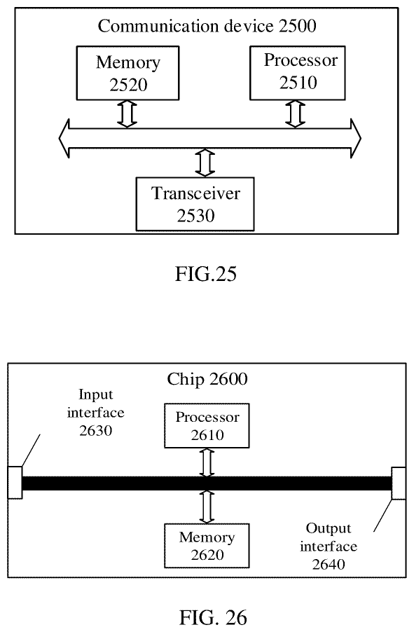

FIG. 25 is a schematic structural diagram of a communication device 2500 according to embodiments of the present application. The communication device 2500 includes a processor 2510, and the processor 2510 can invoke a computer program from a memory and run the computer program, to cause the communication device 2500 to implement the method in the embodiments of the present application.

In an implementation, the communication device 2500 can further include a memory 2520. The processor 2510 can invoke the computer program from the memory 2520 and run the computer program, to cause the communication device 2500 to implement the method in the embodiments of the present application.

The memory 2520 may be a separate device independent of the processor 2510, or may be integrated into the processor 2510.

In an implementation, the communication device 2500 can further include a transceiver 2530, and the processor 2510 can control the transceiver 2530 to communicate with other devices. Specifically, the processor 2510 may control the transceiver 2530 to transmit information or data to other devices, or to receive information or data transmitted by other devices.

The transceiver 2530 may include a transmitter and a receiver. The transceiver 2530 may further include antennas, and the number of antennas may be one or more.

In an implementation, the communication device 2500 may be the network device in the embodiments of the present application, and the communication device 2500 may implement the corresponding processes implemented by the network device in various methods in the embodiments of the present application, which will not be repeated here for the sake of brevity.

In an implementation, the communication device 2500 may be the terminal device in the embodiments of the present application, and the communication device 2500 may implement the corresponding processes implemented by the terminal device in various methods in the embodiments of the present application, which will not be repeated here for the sake of brevity.

In an implementation, the communication device 2500 may be the core network element in the embodiments of the present application, and the communication device 2500 may implement the corresponding processes implemented by the core network element in various methods in the embodiments of the present application, which will not be repeated here for the sake of brevity.

In an implementation, the communication device 2500 may be the access network device in the embodiments of the present application, and the communication device 2500 may implement the corresponding processes implemented by the access network device in various methods in the embodiments of the present application, which will not be repeated here for the sake of brevity.

FIG. 26 is a schematic structural diagram of a chip 2600 according to embodiments of the present application. The chip 2600 includes a processor 2610, and the processor 2610 may invoke a computer program from a memory and run the computer program, to implement the method in the embodiments of the present application.

In an implementation, the chip 2600 may further include a memory 2620. The processor 2610 may invoke the computer program from the memory 2620 and run the computer program, to implement the method performed by the terminal device, the network device, the core network element, or the access network device in the embodiments of the present application.

The memory 2620 may be a separate device independent of the processor 2610, or may be integrated into the processor 2610.

In an implementation, the chip 2600 may further include an input interface 2630. The processor 2610 may control the input interface 2630 to communicate with other devices or chips, and specifically, to obtain information or data transmitted by other devices or chips.

In an implementation, the chip 2600 may further include an output interface 2640. The processor 2610 may control the output interface 2640 to communicate with other devices or chips, and specifically, to output information or data to other devices or chips.

In an implementation, the chip may be applied to the network device in the embodiments of the present application, and the chip may implement the corresponding processes implemented by the network device in various methods in the embodiments of the present application, which will not be repeated here for the sake of brevity.

In an implementation, the chip may be applied to the terminal device in the embodiments of the present application, and the chip may implement the corresponding processes implemented by the terminal device in various methods in the embodiments of the present application, which will not be repeated here for the sake of brevity.

The chips applied in the network device, the terminal device, the core network element and the access network device may be the same chip or different chips.

It should be understood that the chip mentioned in the embodiments of the present application may also be referred to as a system-level chip, a system chip, a chip system, or a system-on-chip chip.

The processor mentioned above may be a general-purpose processor, a digital signal processor (DSP), a field programmable gate array (FPGA), an application specific integrated circuit (ASIC) or another programmable logic device, a transistor logic device, or a discrete hardware component. The general-purpose processor mentioned above may be a microprocessor or any conventional processor.

The memory mentioned above may be a volatile memory or a non-volatile memory, or may include both the volatile memory or the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that the above memories are exemplary but are not limited illustration. For example, the memory in embodiments of the present application may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM). That is, the memories in the embodiments of the present application are intended to include, but are not limited to, these and any other suitable types of memories.

In the above embodiments, all or part of them may be implemented by software, hardware, firmware or any combination thereof. When implemented using software, all or part of the above embodiments may be implemented in the form of a computer program product. The computer program product includes one or more computer instructions. When the computer program instruction(s) are loaded and executed on a computer, the processes or functions described in the embodiments of the present application are generated in whole or in part. The computer may be a general-purpose computer, a special purpose computer, a computer network, or any other programmable device. The computer instruction(s) may be stored in a non-transitory computer-readable storage medium, or transmitted from a non-transitory computer-readable storage medium to another non-transitory computer-readable storage medium. For example, the computer instruction(s) may be transmitted from a website, computer, server, or data center to another website, computer, server, or data center via a wired manner (e.g., coaxial cable, optical fiber, or digital subscriber line (DSL)) or a wireless manner (e.g., infrared, wireless, or microwave). The non-transitory computer-readable storage medium may be any available medium that can be read by a computer or a data storage device such as a server or a data center that includes one or more available medium. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

It should be understood that, in the various embodiments of the present application, the magnitudes of the serial numbers of the above processes do not mean the order of execution. The order of execution of the processes should be determined by their functions and internal logic, and should not constitute any limitation on the implementation process of the embodiments of the present application.

It may be clearly understood by those skilled in the art that, for convenience and brevity of the description, the specific working processes of the system, devices and units described above may refer to the corresponding processes in the aforementioned method embodiments, which will not be repeated here.

The above descriptions are only specific implementations of the present application, but the protection scope of the present application is not limited thereto. Changes or replacements that any person skilled in the art could readily conceive of within the technical scope of the present application shall be included in the protection scope of the present application. Therefore, the protection scope of the present application shall be subject to the protection scope of the claims.

What is claimed is:

1. A third network device, comprising: a processor and a memory, wherein the memory is configured to store a computer program, and the processor is configured to invoke the computer program stored in the memory and run the computer program, to cause the third network device to perform:
receiving a feature profile of a first use case;
determining at least one of a network device, a terminal device or a node required to execute the first use case based on the feature profile; and
transmitting a configuration parameter in the feature profile to the at least one of the network device, the terminal device or the node required to execute the first use case.

2. The third network device according to claim 1, wherein the processor is configured to invoke the computer program stored in the memory and run the computer program, to cause the third network device to further perform:
obtaining model data required for the first use case from a fifth network device based on the feature profile of the first use case; and
transmitting the model data required for the first use case to the at least one of the network device, the terminal device, or the node required to execute the first use case.

3. The third network device according to claim 1, wherein the processor is configured to invoke the computer program stored in the memory and run the computer program, to cause the third network device to further perform:
receiving execution result(s) of the first use case from the at least one of the network device, the terminal device, or the node required to execute the first use case, wherein an execution result comprises a first feature identification of the first use case; and
aggregating received multiple execution results based on the first feature identification comprised in the execution result.

4. The third network device according to claim 3, wherein the execution result further comprises at least one of:
a type of a parameter that needs to be collected for the first use case; or
a time window and/or an area required by the first use case.

5. The third network device according to claim 4, wherein the processor is configured to invoke the computer program stored in the memory and run the computer program, to cause the third network device to further perform:
transmitting, by the third network device, an aggregated execution result to a first network device.

6. The third network device according to claim 1, wherein the feature profile of the first use case comprises at least one of the following feature parameters:
a type of a parameter that needs to be collected for the first use case;
a model to be adopted for the first use case;
a network element and/or a node that need to be invoked by the first use case;
a time window and/or an area required by the first use case;
an identification of a terminal device involved in the first use case; or
an identification of an application that initiates the first use case.

7. The third network device according to claim 6, wherein the type of the parameter is represented by a dataset identification.

8. The third network device according to claim 1, wherein the first use case comprises a vertical federated learning (VFL) use case.

9. The third network device according to claim 3, wherein the first feature identification indicates at least one of:
a type of the first use case; or
an operation for executing the first use case;
wherein the type of the first use case comprises at least one of:
statistics and/or prediction of quality of experience (QoE); or
statistics and/or prediction of energy efficiency (EE);
wherein the operation for executing the first use case comprises: a VFL operation.

10. The third network device according to claim 1, wherein the third network device comprises a network data analytics function (NWDAF);
the fifth network device comprises an analytics data repository function (ADRF); and
the first network device comprises a network exposure function (NEF).

11. A communication method, comprising:
receiving, by a terminal device, a configuration parameter in a feature profile of a first use case, model data required for the first use case, and a first feature identification of the first use case; and
transmitting, by the terminal device, an execution result of the first use case, wherein the execution result comprises the first feature identification of the first use case.

12. The method according to claim 11, wherein the execution result further comprises at least one of:
a type of a parameter that needs to be collected for the first use case; or
a time window and/or an area required by the first use case.

13. The method according to claim 12, wherein the type of the parameter is represented by a dataset identification.

14. The method according to claim 11, wherein the first use case comprises a vertical federated learning (VFL) use case.

15. The method according to claim 11, wherein the first feature identification indicates at least one of:
a type of the first use case; or
an operation for executing the first use case;
wherein the type of the first use case comprises at least one of:
statistics and/or prediction of quality of experience (QoE); or
statistics and/or prediction of energy efficiency (EE);
wherein the operation for executing the first use case comprises: a VFL operation.

16. A terminal device, comprising: a processor, a memory and a transceiver, wherein the memory is configured to store a computer program, and the processor is configured to invoke the computer program stored in the memory and run the computer program, and control the transceiver to perform:
receiving a configuration parameter in a feature profile of a first use case, model data required for the first use case, and a first feature identification of the first use case; and
transmitting an execution result of the first use case, wherein the execution result comprises the first feature identification of the first use case.

17. The terminal device according to claim 16, wherein the execution result further comprises at least one of:
a type of a parameter that needs to be collected for the first use case; or
a time window and/or an area required by the first use case.

18. The terminal device according to claim 17, wherein the type of the parameter is represented by a dataset identification.

19. The terminal device according to claim 16, wherein the first use case comprises a vertical federated learning (VFL) use case.

20. The terminal device according to claim 16, wherein the first feature identification indicates at least one of:
a type of the first use case; or
an operation for executing the first use case;
wherein the type of the first use case comprises at least one of:
statistics and/or prediction of quality of experience (QoE); or
statistics and/or prediction of energy efficiency (EE);
wherein the operation for executing the first use case comprises: a VFL operation.
